(19) United States
(12) Patent Application Publication
(10) Pub. No.: US 2026/0214593 A1
(43) Pub. Date: Jul. 23, 2026

(54) WIRELESS RADIO ACCESS NETWORK RF CELL POWER DETERMINATION

(71) Applicant: AT&T Intellectual Property I, L.P., Atlanta, GA (US)

(72) Inventors: Tanvi Alam, Roswell, GA (US); Syed Anwar Aftab, Budd Lake, NJ (US); Anandarup Sarkar, Belle Mead, NJ (US)

(73) Assignee: AT&T Intellectual Property I, L.P., Atlanta, GA (US)

(21) Appl. No.: 19/034,181

(22) Filed: Jan. 22, 2025

(51) Int. Cl. H04W 52/22; H04W 28/18

(52) U.S. Cl. CPC H04W 52/228; H04W 28/18

(57) ABSTRACT

Aspects of the subject disclosure may include, for example, a device that trains a RF Power Large Language Model (RFP-LLM) using historical RF power data, cell site geography, RF use case constraints, vendor product capabilities, FCC power restrictions, and O-RAN standards. An interactive Generative AI-driven chatbot queries the RFP-LLM for RF power configuration plans for one or more cell sites. A simulation engine evaluates these plans, and the system modifies network configurations to implement the plans, and continuously improves the RFP-LLM with simulation results and feedback. Other embodiments are disclosed.

### FIELD OF THE DISCLOSURE

The subject disclosure relates to wireless communication technologies, specifically to radio frequency (RF) power in wireless radio access networks.

### BACKGROUND

The provisioning, planning, and optimization of Radio Frequency (RF) power for cell sites is a complex and dynamic task. It requires a deep understanding of RF propagation models, hardware limitations, regulatory compliance, geographic terrain, antenna models, neighboring cell traffic, seasonal patterns, and various other parameters. These parameters often change over time, necessitating quick adjustments and periodic reconfigurations to maintain optimal cell power and coverage while adhering to regulatory requirements, such as those from the Federal Communications Commission (FCC).

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for Generative AI-driven RF power system design and configuration for communications networks. Other embodiments are described in the subject disclosure.

Correct provisioning, planning and optimization of Radio Frequency (RF) power for cell sites is a complex task, typically requiring a deep understanding of RF propagation models, vendor-supplied hardware supportive limits, FCC compliance mandates, local market geographic terrain, antenna models, neighboring cell traffic, seasonal patterns, bands, frequencies, technologies, channel sensitivity, and various other parameters. Some of these parameters are dynamically changing over time and a quick provisioning and periodic computation and re-configuration of cell site antenna transmission power is used based on all influencing parameters to optimize cell power and maintain good site coverage footprint, at the same time, conforming to all FCC RF mandates (for example, ensuring RF safety and prevent human overexposure health hazards).

RF power provisioning becomes even more difficult for network operators in a Virtualized Open RAN (O-RAN) context, where RF engineers need to integrate components from different vendors communicating over standardized interfaces and protocols using a more general-purpose, nonproprietary framework to decouple hardware and software functions. Various embodiments described herein provide a proactive aid for RF power configurations in cell sites. This enables the RF designers and engineers to perform pre-emptive power configuration management on existing and new cell sites so that a continuous, consistent balance may be preserved between quality network coverage and FCC norms compliance. Various embodiments described herein analyze cell site baseband, radio and antenna models from different vendors complying to O-RAN interoperability standardized specifications, local geographic terrain, neighboring cell traffic, seasonal subscriber usage pattern, FCC RF regulation mandates, and pre-emptively aid RF designers to configure the cell power.

The various embodiments train upon these aforementioned parameters in O-RAN context and then apply a GenAI driven approach to aid RF engineers in uncovering and overcoming various bottlenecks they face in end-to-end cell site power optimization for every site on a nationwide scale across all spectrum bands, satisfying various competing RF power use case needs, FCC mandates, and O-RAN constraints. The various embodiments may provide robust operation even in the presence of new, unknown, input parameters or if trends in parameters exist, which may affect the coverage prediction in a yet, unknown way, which may violate conformance to different, competing RF use case needs. Also, with the continuous emergence of new network hardware vendors and to keep up with the evolving standards, specifications and interfaces in O-RAN architecture aligned with the advancements in 5G and development planning for 6G, the various embodiments provide RF designers with tools to detect and resolve continuous challenges in RF power management to adhere to O-RAN vendor-interoperability goals and meet different RF use case demands.

One or more aspects of the subject disclosure include a device, comprising: a processing system including a processor; and a memory that stores executable instructions that, when executed by the processing system, facilitate performance of operations. The operations may include training an RF Power Large Language Model (RFP-LLM) using historical RF cell power configurations, cell site geographies, vendor hardware and software specifications, FCC requirements, and O-RAN standards; providing an interactive Generative AI-driven chatbot configured to query the RFP-LLM to determine RF power settings for cell sites; generating, by the RFP-LLM, RF power configuration plans for the cell sites; simulating, by a simulation engine, the RF power configuration plans to evaluate an effectiveness in meeting competing RF use case needs and conforming to Federal Communications Commission (FCC) requirements; and reconfiguring at least one RF cell power component based on the RF power configuration plans.

One or more aspects of the subject disclosure include a non-transitory machine-readable medium, comprising executable instructions that, when executed by a processing system including a processor, facilitate performance of operations. The operations may include training an RF Power Large Language Model (RFP-LLM) using vendor hardware and software specifications, FCC requirements, and O-RAN standards; providing an interactive Generative AI-driven chatbot configured to query the RFP-LLM to determine RF component selections for cell sites; generating, by the RFP-LLM, RF power configuration plans for the cell sites; simulating, by a simulation engine, the RF power configuration plans to evaluate an effectiveness in meeting competing RF use case needs and conforming to Federal Communications Commission (FCC) requirements; and modifying at least one RF cell power component based on the RF power configuration plans.

One or more aspects of the subject disclosure include a method, comprising: training by a processing system including a processor, an RF Power Large Language Model (RFP-LLM) using historical RF cell power configurations, vendor hardware and software specifications, FCC requirements, and O-RAN standards; providing, by the processing system, an interactive Generative AI-driven chatbot configured to query the RFP-LLM to determine RF power settings for cell sites; generating, by the processing system using the RFP-LLM, RF power configuration plans for the cell sites; training the RFP-LLM, by the processing system, using simulation results from a simulation of the RF power configuration plans; and reconfiguring at least one RF cell power component based on the RF power configuration plans.

Additional aspects of the subject disclosure may include training the RFP-LLM using simulation results. The operations may also include modifying a network configuration based on the simulation results; wherein reconfiguring at least one power component comprises setting an output power of an amplifier; wherein the training the RFP-LLM comprises training using iterative prompt engineering by network domain experts; and wherein the simulation engine is configured to simulate the RF power configuration plans in a controlled environment during off-business hours to minimize impact on live network operations.

Further aspects of the subject disclosure additionally include continuously monitoring network performance Key Performance Indicators (KPIs) to detect and mitigate any adverse impact; training the RFP-LLM using feedback from network operators to improve the predictive accuracy of the RFP-LLM; reconfiguring at least one RF power component by changing an antenna tilt; reconfiguring at least one RF power component by selecting a baseband unit, an amplifier, an antenna, or any combination thereof.

Yet additional aspects of the subject disclosure include modifying at least one RF cell power component by selecting a baseband unit to be used in the RF cell; selecting a power amplifier unit to be used in the RF cell; selecting an antenna to be used in the RF cell; and selecting a plurality of amplifiers to be used in a plurality of RF cells.

More aspects may involve generating the RF power configuration plans by determining an amplifier model to be used in a plurality of cell sites; determining an amplifier transmit power level; determining a baseband unit model to be used in a plurality of cell sites; and determining an antenna model to be used in a plurality of cell sites.

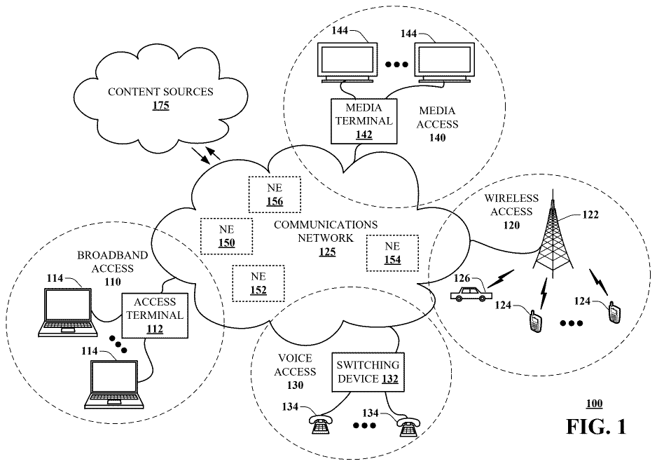

Referring now to FIG. 1, a block diagram is shown illustrating an example, non-limiting embodiment of a system 100 in accordance with various aspects described herein. For example, system 100 can facilitate in whole or in part Generative AI-driven RF power system design and configuration for communications networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In some embodiments, Base station 122 or access point may include several key components, such as a Baseband Unit (BBU), radio units, and antennas, which work together to manage and transmit wireless signals.

In some embodiments, the BBU within base station or access point 122 processes incoming and outgoing data, handling tasks such as signal modulation and demodulation, encoding, and decoding. For example, the BBU may support multiple network standards, such as 4G and 5G, allowing for flexible network deployments. The radio units in base station 122 are responsible for converting the processed signals from the BBU into radio waves that can be transmitted through the antennas. These radio units may operate on specific frequency bands, providing the necessary power output to cover the intended geographic area. The antennas, in turn, emit the radio waves into the environment, facilitating communication with user devices. They may have adjustable tilt and orientation settings to optimize signal coverage and reduce interference.

In some embodiments, power configuration plans generated by an RF Power Large Language Model (RFP-LLM), described further below, can be used to modify the configuration of base station or access point 122. In some embodiments, these plans provide detailed recommendations for adjusting the power output of the radio units, selecting appropriate antenna models, and configuring the BBU to achieve desired performance levels. For example, the power configuration plans may suggest increasing the power output of the radio units to enhance coverage in rural areas or adjusting the antenna tilt to improve signal penetration in urban environments. By implementing these recommendations, network operators can ensure that base station or access point 122 operates efficiently, providing reliable service while adhering to regulatory constraints and minimizing interference with other networks.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

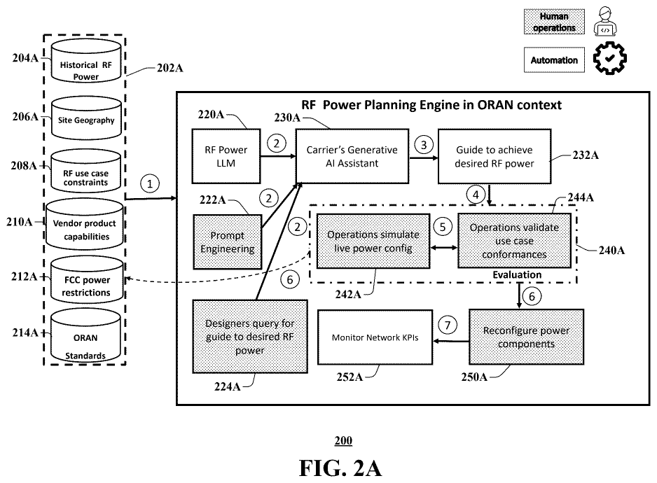

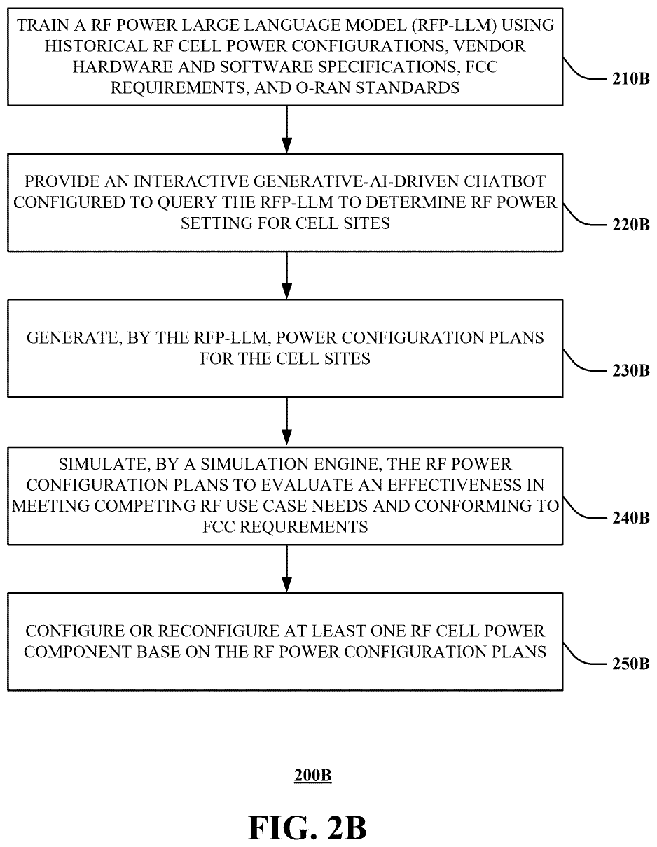

FIG. 2A is a block diagram illustrating an example, non-limiting embodiment of a system functioning within the communication network of FIG. 1 in accordance with various aspects described herein. System 200 illustrates an RF Power Planning Engine in an O-RAN context. System 200 leverages various sources of data and AI-driven techniques to optimize the RF power configurations for cell sites. System 200 includes training data 202A, RF-LLM training operation 220A, prompt engineering operation 222A, desired RF power query operation 224A, Generative AI Assistant 230A, guide to achieve desired RF power 232A, evaluation 240A, Power Configuration Simulation operation 242A, use case conformances validation operation 244A, reconfiguration of power components 250A, and network KPIs monitoring operation 252A. Training data 202A includes historical RF power 204A, site geography 206A, RF use case constraints 208A, vendor product capabilities 210A, FCC power restrictions 212A, and O-RAN standards 214A. The sources of training data 202A shown in FIG. 2A are provided as examples, and are not meant to be limiting. For example, many other sources and/or types of training may be included.

Historical RF Power 204A represents historical RF power data. In some embodiments, this component stores historical records of RF power settings and their outcomes, aiding in predictive analysis for future configurations. For example, historical power levels used in different geographic locations can be reviewed to identify patterns and inform future decisions.

Historical RF power 204A encompasses a detailed repository of past RF power settings used across various cell sites, capturing the fluctuations and adjustments made over time to address different operational conditions. In some embodiments, historical RF power 204A includes records of power levels for transmission and reception at different times of the day, days of the week, and seasons. For example, a cell site located in a commercial district might have higher RF power settings during business hours to handle increased traffic, while the same site might reduce power at night or on weekends. Similarly, data from cell sites in residential areas could show higher power usage during evenings and weekends when people are more likely to be at home.

Historical RF power data can also include adjustments made during special events. For instance, during a large sporting event or concert, temporary increases in RF power might be recorded to accommodate the surge in network demand. Conversely, areas affected by maintenance or outages might have records of reduced power settings or alternative configurations used to manage limited capacity.

Site Geography 206A includes site geography data and organizes and provides geographic information useful for RF planning and configuration. In some embodiments, Site Geography 206A may store details about terrain types, building densities, and other geographic features that can affect RF signal propagation.

In some embodiments, the site geography 206A is linked with the historical RF power 204A for understanding the context in which power settings were applied. Site geography may include various environmental factors such as terrain elevation, building density, and vegetation coverage, which can significantly impact RF signal propagation and strength. For example, a cell site in a densely built urban area might show records of higher power settings to overcome obstructions and ensure effective signal coverage, whereas a rural cell site with wide-open spaces might operate efficiently at lower power levels.

In some embodiments, integrating historical RF power data with site geography data provides a more comprehensive understanding of past RF configurations. For example, analyzing power settings in conjunction with geographic information might reveal patterns such as the need for higher power levels in areas with tall buildings or the effectiveness of lower power settings in open terrain. This combined analysis helps identify optimal power configurations for various geographic scenarios.

As further described below, training the RF Large Language Model (RFP-LLM) using this integrated data set leverages the historical context to improve predictive accuracy. In some embodiments, Historical RF power 204A provides real-world examples of how different power settings have been used to address various challenges, while site geography 206A offers insight into the environmental conditions influencing those settings. For example, training the RFP-LLM with data showing increased power levels in hilly areas or during rainy seasons can help the model predict similar adjustments for future configurations in analogous situations.

Further, in some embodiments, the RFP-LLM can also benefit from recognizing recurring patterns in the historical RF power data linked with specific geographic features. For instance, if the model learns that sites near water bodies often require periodic adjustments to manage signal reflection and refraction, it can proactively suggest similar configurations for new sites with similar geographic characteristics. Further, the model can identify anomalies or deviations from expected patterns, prompting closer examination or adjustments based on evolving conditions.

RF Use Case Constraints 208A includes RF use case constraints and sets operational limits and requirements for different RF scenarios. For example, RF Use Case Constraints 208A may outline maximum permissible power levels for varying contexts such as urban versus rural deployments to ensure optimal performance without regulatory violations.

In some embodiments, RF use case constraints 208A encompass a set of parameters and limitations specific to various RF use cases. These constraints provide guidance for various RF configurations so that they not only meet technical requirements but also comply with regulatory standards and operational needs. In some embodiments, the RF use case constraints 208A may be linked to other types of training data, thereby enhancing the training of the Large Language Model (LLM).

RF Use Case Constraints may specify RF parameter values (e.g., allowable frequency bands, minimum or maximum power, modulation requirements, etc.) as standalone values or as a function of other parameters such as site geography, cell site location or any other variable.

RF use case constraints may be determined based on any key performance indicator (KPI). Examples include interference management (e.g., inter-cell interference or avoiding interference in between network operators and digital radio audio carriers or between satellite operators and cellular providers), quality of service (QoS) requirements, target coverage requirements, regulatory compliance,

In some embodiments, RF use case constraints may be based at least in part on interference management. For example, two adjacent cells operating on the same frequency band may have their power levels adjusted to reduce or omit overlap and prevent signal degradation. Further, in regions near national borders, RF power settings may be configured to avoid interference with networks operating in the neighboring country. For example, lower power levels may be used for cells near the border to comply with international agreements.

In some embodiments, RF use case constraints may be based at least in part on QoS requirements, where different applications may have varying QoS requirements. For example, video streaming services typically require high data rates and low latency, necessitating higher RF power levels, while voice calls may tolerate slightly higher latency and lower data rates. Further in high-density areas, such as stadiums or urban centers, higher RF power settings may be desired to ensure adequate coverage and capacity for a large number of users simultaneously accessing the network.

In some embodiments, RF use case constraints may be based at least in part on target are coverage. For example, RF power settings may be adjusted to cover specific geographic areas. For example, rural cell sites may need higher power levels to cover larger areas with fewer cell sites, while urban sites may focus on smaller, denser coverage areas. In addition, in certain use cases, such as providing coverage along highways or railways, tailored RF power configurations may be desired to ensure seamless connectivity for mobile users.

In some embodiments, RF use case constraints may be based at least in part on regulatory compliance. For example, RF power levels may be adjusted to comply with safety regulations to avoid harmful radiation exposure to humans. For example, the FCC imposes strict limits on the maximum allowable RF transmission power to ensure public safety. Further, RF power settings may be adjusted according to spectrum licensing. For example, RF power settings may be adjusted to adhere to the conditions specified in spectrum licenses. For example, certain frequency bands may have specific power restrictions to prevent interference with other services or satellite communications.

Vendor Product Capabilities 210A stores vendor product capabilities, detailing the technical specifications and performance metrics of hardware from various vendors. For example, it includes the output power limits, efficiency levels, and compatibility information of different RF amplifiers and antennas.

In some embodiments, Vendor product capabilities 210A refer to the specific features, specifications, and limitations of RF equipment provided by various vendors. Understanding these capabilities is useful for optimizing RF power configurations and ensuring that the network utilizes the most appropriate hardware and software to meet its operational goals. Different antenna models offer varying levels of gain, such as high-gain antennas used in rural areas to extend coverage over long distances and lower-gain antennas better suited for urban environments with dense building structures. Some modern antennas support advanced beamforming techniques, dynamically adjusting the direction of their signal beams to target specific areas, which is useful in high-traffic areas like stadiums or concert venues. Antennas also may have adjustable electrical or mechanical tilt settings to focus the RF signal more directly towards the target coverage area, improving signal strength and reducing interference with neighboring cells.

Baseband Units (BBUs) differ in their processing power and capacity to handle large numbers of simultaneous connections, useful for cell sites in densely populated urban areas. Some BBUs support multiple network standards such as 4G, 5G, and beyond, allowing for more flexible network deployments and easier upgrades as new technologies emerge. Advanced BBUs might include features designed to minimize latency, which is useful for real-time communication applications such as video conferencing and online gaming. Remote Radio Units (RRUs) have varying power output levels, influencing the coverage area and signal strength; high-power RRUs may be used to cover large rural areas, while lower power RRUs might be employed in dense urban settings to limit interference. Different RRUs are designed to operate in specific frequency bands, with some supporting low-frequency bands for extensive coverage, while others are optimized for high-frequency millimeter-wave bands to provide high-capacity, high-speed connections. Advanced RRUs may support multiple-input and multiple-output (MIMO) technology, increasing network capacity without requiring additional spectrum, simultaneously supporting multiple data streams to enhance user throughput and reliability.

Incorporating vendor product capabilities into the training data for the RF Large Language Model (RFP-LLM) provides several benefits that enhance the model's predictive accuracy and its ability to make informed recommendations. Training on vendor product capabilities helps the LLM develop a comprehensive understanding of the features and limitations of various RF equipment, ensuring that the model's recommendations are grounded in the real-world capabilities of the hardware and software used in the network. Knowledge of vendor product capabilities enables the LLM to make context-aware recommendations, such as suggesting specific antenna models with high-gain and beamforming features for high user density or challenging coverage requirements.

As further described below, in some embodiments, the LLM can recommend the most suitable equipment configurations based on the specific needs of each site, such as suggesting high-capacity BBUs for urban areas with heavy data traffic or low-power RRUs for areas requiring minimal interference. As network demands and conditions change, the LLM can dynamically adapt recommendations, such as suggesting appropriate upgrades to baseband units and antennas to support increased load from a new high-capacity application. Training on vendor product capabilities also helps the LLM navigate interoperability challenges, identifying compatible hardware and software combinations from different vendors to ensure seamless integration and operation.

In some embodiments, the LLM can proactively recommend software-based optimizations by understanding the capabilities of advanced software solutions, such as enabling self-optimizing network (SON) features to automatically adjust RF power levels in response to fluctuating network conditions. Detailed knowledge of vendor product capabilities allows the LLM to provide targeted solutions to specific network issues, such as deploying interference mitigation software or adjusting antenna tilt angles to alleviate high interference. Training the LLM on vendor product capabilities allows for more efficient network planning and deployment, recommending optimal configurations that maximize network performance while minimizing costs by selecting the most appropriate and cost-effective equipment. Integrating vendor product capabilities into the training data enriches the RFP-LLM, equipping it with the knowledge needed to make precise, contextually relevant, and actionable recommendations, ensuring that the model's predictions and guidance are tailored to the unique capabilities of the network's hardware and software, leading to more effective RF power planning and optimization.

FCC Power Restrictions 212A includes FCC power restrictions that ensure compliance with Federal Communications Commission regulations. In some embodiments, this component may track legal limits on RF exposure to prevent human health safety violations and ensure safe operation.

Open Radio Access Network (O-RAN) Standards 214A defines O-RAN standards, ensuring that all equipment and software meet the interoperability standards of the Open Radio Access Network framework. In some embodiments, O-RAN standards includes information that allows compatibility and interoperability of components from different vendors.

In some embodiments, O-RAN standards 214A pertain to a set of guidelines and specifications developed by the Open Radio Access Network (O-RAN) Alliance. The O-RAN Alliance is an industry consortium working to redefine and standardize RAN (Radio Access Network) architecture with a focus on openness, intelligence, and flexibility. The primary goal of O-RAN standards is to foster interoperability among different vendors'equipment, enabling network operators to build and manage RAN infrastructure using components from multiple suppliers rather than being locked into proprietary solutions from a single vendor.

In some embodiments, O-RAN standards 214A may include frameworks for the interfaces between different RAN elements. For example, these standards define the communication protocols that should be used between baseband units (BBUs) and remote radio units (RRUs), ensuring that devices from different manufacturers can work together seamlessly.

Additionally, O-RAN standards 214A may address network function virtualization (NFV) and cloud-native implementations. For example, the standards specify how RAN functionalities can be decoupled from dedicated hardware and run as virtualized network functions (VNFs) on general-purpose servers, facilitating dynamic scaling and increased operational flexibility.

In general, the O-RAN standards aim to promote competition, innovation, and cost-efficiency within the RAN ecosystem by creating an open and modular architecture. This approach allows network operators to mix and match hardware and software components from various vendors, reducing dependencies on single-vendor solutions and enabling more rapid adoption of new technologies.

RF Power LLM Training operation 220A facilitates the training of the RF Power Large Language Model (RFP-LLM). This component uses the compiled training data from components 204A through 214A to train the RFP-LLM. It applies machine learning techniques to enhance the model's accuracy in predicting RF power settings. This process integrates various inputs such as historical RF power settings, site geography, RF use case constraints, vendor product capabilities, FCC power restrictions, and O-RAN standards to develop a comprehensive and predictive model that supports optimal or near-optimal RF power configurations for cell sites. In some embodiments, the LLM may be a transformer-based model, which is particularly adept at handling sequential data and generating coherent context-aware predictions. For example, models such as GPT (Generative Pre-trained Transformer), BERT (Bidirectional Encoder Representations from Transformers), or T5 (Text-to-Text Transfer Transformer) may be employed. These models have proven capabilities in encoding complex and context-rich dependencies, making them suitable for the intricate task of RF power configuration predictions.

A specific example of model implementation could include utilizing a generative pre-trained transformer model such as GPT-4, which can be fine-tuned using domain-specific data. The model can be trained on extensive datasets comprising historical RF power settings from various cell sites, geographical information, RF use case scenarios, specifications of different vendor products, and regulatory FCC power restrictions. With such a configuration, the RF Power LLM can generate recommendations for optimal RF power settings by constructing detailed and contextually accurate predictions. An encoder-decoder based BERT model can also be adapted for this context by focusing on understanding and embedding domain-specific nuances. Training this BERT model using RF use-case constraints and vendor-specific hardware capabilities allows it to effectively comprehend and derive patterns from past RF configurations, compliance requirements, and other related dynamics. Similarly, the Text-to-Text Transfer Transformer (T5) model can treat various training tasks as text-to-text tasks. For instance, input parameters like historical power settings, site geography, and FCC restrictions can be fed into the model in text format, and the output can be predictions of optimal RF configurations. T5's flexible architecture permits seamless integration of the diverse dataset into a coherent model capable of generating highly accurate RF configuration recommendations.

In each of these models, iterative training and validation processes may be conducted to refine the RF Power LLM. In some embodiments, domain experts may continually adjust prompt engineering, fine-tune hyperparameters, and incorporate simulation results to ensure that the model's predictions stay relevant and compliant with evolving standards and hardware capabilities. The robustness of the model is further enhanced by incorporating real-world feedback and adapting to unforeseen configuration challenges that network operators might encounter. By employing advanced LLMs such as GPT, BERT, or T5, the RF Power LLM within block 220A can generate reliable, data-driven insights tailored to the specific needs of RF power management, enabling network engineers to maintain optimal configurations across diverse operational scenarios.

Prompt Engineering (222A) involves refining the RF Power LLM's responses based on iterative feedback. Network domain experts might adjust prompts to improve the relevance and accuracy of the model's outputs. Prompt engineering involves crafting and iterating on the questions or prompts given to the LLM to ensure that it understands the context and nuances of the query, ultimately enhancing the quality and reliability of the responses generated by the model.

One goal of prompt engineering is to tailor the input queries to elicit more precise, contextually relevant, and actionable information from the LLM. This process can significantly impact the effectiveness of the LLM in providing optimal RF power configurations, as it helps align the model's outputs with the specific needs and constraints of RF engineers and network operators.

In some embodiments, prompt engineering involves iterative refinement by domain experts who understand both the technical aspects of RF power management and the capabilities of the LLM. For example, an initial query to the LLM might be broad, such as “What is the optimal RF power setting for a given cell site?” Through prompt engineering, this query can be refined to include more specific details, such as the geographical context, historical performance data, and any regulatory constraints. A refined query might look like: “Given a suburban cell site with dense foliage, historical average RF power settings of 30 dBm, and a requirement to comply with FCC regulations, what is the optimal RF power setting and necessary hardware adjustments?”

An example of how prompt engineering may improve the results of queries to the LLM can be illustrated with a scenario where RF engineers need to address interference issues in a densely populated urban area. Initially, the engineers might query the LLM with a general question like, “How can we reduce interference in an urban cell site?” The LLM might provide a range of suggestions that are too broad or not entirely relevant to the specific context.

By employing prompt engineering, the engineers can refine the query to include specific parameters and constraints that the LLM should consider. For instance, the revised query could be: “Considering an urban cell site located in downtown, with a high density of high-rise buildings and known interference from adjacent cell sites, what adjustments to RF power settings and antenna configurations can minimize interference ensure FCC compliance, while maintaining a reasonable coverage footprint?” This refined query provides the LLM with more context and specific details, leading to more targeted and useful recommendations.

In this scenario, the LLM might respond with detailed suggestions such as: “Reduce the RF power setting to 28 dBm, adjust the antenna tilt to 15 degrees to avoid signal reflection from nearby buildings, and switch to a specific hardware model that offers better interference mitigation capabilities.” These detailed and contextually relevant recommendations are a direct result of effective prompt engineering.

Desired RF Power Query Operation 224A represents the process wherein RF engineers, designers, or domain experts input queries into the system to determine the optimal RF power settings (e.g., power configuration plans) for one or more cell sites. The Desired RF Power Query Operation 224A is a step where the user interacts with the Generative AI-driven system, utilizing the trained RF Power LLM to seek guidance and recommendations for configuring RF power at various cell sites.

The Desired RF Power Query Operation 224A involves RF engineers, designers, or domain experts inputting queries into the system to determine the optimal RF power settings for a given cell site. This component leverages the trained RF Power Large Language Model (RFP-LLM), which has been built using historical RF power data, site geography, RF use case constraints, vendor product capabilities, FCC power restrictions, and O-RAN standards, to provide detailed and actionable recommendations for configuring RF power. In some embodiments, RF engineers enter their queries through a user-friendly interface, such as a web-based dashboard or mobile application, where they can specify the conditions and requirements for the cell site. The RFP-LLM processes these queries, considering all relevant factors, to generate an RF power configuration plan tailored to the site's unique needs.

For example, an RF engineer might input a query such as: “What is the optimal RF power setting for a cell site in a suburban area with moderate tree coverage, aiming to maximize coverage while adhering to FCC regulations and minimizing interference with nearby cell sites?” The RFP-LLM would analyze this query and generate a comprehensive power configuration plan. This plan might recommend setting the RF power level to 29 dBm, considering the moderate tree coverage that could cause signal attenuation. The power level is optimized to ensure sufficient coverage while minimizing power usage and interference risks. The model could suggest specific adjustments to the antenna tilt and azimuth angles, such as adjusting the antenna tilt to 12 degrees downward and aligning the azimuth angle to 45 degrees to help target the desired coverage area more effectively and avoid signal spillover to regions served by other cell sites. The RFP-LLM might suggest appropriate hardware models from different vendors to achieve the desired power settings and coverage. For example, the model could recommend using an Ericsson AIR 6488 radio unit paired with a CommScope 10P-4L6M-D5 antenna, known for their compatibility and performance in suburban environments. The configuration plan would ensure that the recommended power levels and hardware setups comply with FCC regulations. The RFP-LLM would verify that the maximum EIRP (Equivalent Isotropically Radiated Power) does not exceed FCC limits for the given frequency band and geographical location. To address potential interference with nearby cell sites, the RFP-LLM might include strategies such as implementing dynamic frequency selection or adjusting power levels during peak usage times. The plan could call for reducing the RF power level by 2 dBm during high-traffic periods to mitigate interference risks. The model considers site-specific factors like foliage and terrain and might suggest an increased power setting to account for signal loss due to foliage attenuation, along with periodic monitoring to adjust configurations as environmental conditions change.

Additional examples of queries and corresponding power configuration plans the RFP-LLM might generate include optimizing RF power settings for an urban cell site with high-rise buildings to reduce signal reflection and achieve optimal indoor coverage. The plan might decrease RF power to 27 dBm to minimize signal reflection off buildings, set antenna tilt to 10 degrees downward for better indoor penetration, and recommend using a Nokia AirScale 5G radio unit with an adjustable beamforming antenna. For a rural cell site with sparse population, the query might focus on maximizing coverage while conserving energy. The power configuration plan could increase RF power to 35 dBm for extended coverage in low-density areas, set antenna height to 40 meters to maximize line-of-sight coverage, and suggest using a Huawei RRH 4563 outdoor unit that supports energy-efficient transmission modes.

Generative AI Assistant (230A) represents the interactive, AI-driven interface that allows RF engineers, designers, or domain experts to engage with the RF Power Large Language Model (RFP-LLM). The Generative AI Assistant is configured to query the RFP-LLM to provide detailed and contextually relevant recommendations for RF power configurations at cell sites as described above.

The Generative AI Assistant serves as the primary tool through which users interact with the system. It is designed to be user-friendly and accessible. For example, in some embodiments, generative AI assistant 230A takes the form of a web-based dashboard, a mobile application, or a desktop interface. This component leverages the advanced capabilities of the RFP-LLM to process user queries, generate comprehensive RF power configuration plans, and deliver actionable insights to the users.

Example queries may include: “Which baseband, radio, and antenna combinations at the maximum allowable transmit power level will provide an RF coverage of −102 dBm RSRP or better for 850 MHz band in a 50 km radius?” A possible answer from the chatbot might be: “Use Ericsson BB6630 Baseband, AIRSCALE RRH 4T4R B5 160 W AHCA Radio, and Commscope 10P-4L6M-D5 Antenna.” Another query could be: “Which Ericsson Cband radio units can provide at least 50 W power?” The chatbot may reply with: “Use 8863 B7D7D, 4461 B5D7D, and 4435 B7D7.”

Guide to Achieve Desired RF Power 232A offers detailed instructions on attaining optimal RF configurations. It may include methodologies for adjusting antenna angles or calibrating amplifier settings. Operations Simulate Live Power Config (242A) involves creating simulations to test the proposed RF configurations in a controlled environment, using a simulation engine to predict real-world performance before making actual network changes.

In some embodiments, the guide to achieve desired RF power 232A may include detailed power configuration plans specific to the cell sites. For example, the guide might provide optimal power levels for different frequency bands to ensure compliance with FCC regulations and prevent interference with nearby networks or satellite operations. Further, in some embodiments, the power configuration plans might include specific antenna tilt settings to maximize signal coverage in challenging geographical terrains. Additionally, the power configuration plans may specify which vendor hardware components, such as baseband units, radio units, and antenna models, should be used to achieve the desired RF power levels. For instance, the guide may recommend using a particular baseband unit from Vendor A and an antenna model from Vendor B to optimize coverage while minimizing power consumption.

Furthermore, the guide might include specifications for integrating software configurations that can enhance hardware performance. For example, it may suggest implementing a particular version of an antenna tilting software to support more dynamic adjustments in real-time based on traffic load and environmental conditions. The power configuration plans could also provide guidelines on periodic monitoring and adjustments based on changing subscriber usage patterns and seasonal variations, ensuring that the network continuously meets the optimal RF power requirements.

Once the Generative AI Assistant 230A provides a guide, the system moves into the evaluation phase 240A. This phase ensures that the recommendations generated by the AI Assistant are accurate and viable for implementation. The evaluation phase 240A includes use case conformances validation operation 244A and power configuration simulation operation 242A.

The use case conformances validation operation 244A validates the conformance of the recommended configurations against all relevant constraints and standards. For example, it may check for compliance with FCC power restrictions to ensure no regulatory violations, adherence to O-RAN standards for interoperability and vendor-agnostic deployment, and ensures that the configurations do not cause interference with other networks or services. For example, the validation process might involve checking that the power settings do not exceed FCC limits and that all vendor product capabilities are within specified tolerances.

In the power configuration simulation operation 242A, the suggested power configurations and hardware settings are tested within a controlled simulation environment that mimics real-world conditions of the network but occurs during off-business hours to avoid impacting live network operations. The simulation involves testing the compatibility and performance of the recommended configurations, assessing the potential impact on network coverage and RF performance, and identifying any discrepancies or potential issues that may arise during actual deployment. For example, the simulation might test varying power levels to see how they affect coverage in different geographic terrains or how different hardware combinations perform under specific use case constraints.

Once these operations verify the viability and compliance of the recommendations, the system proceeds to reconfiguration of power components 250A, where actual adjustments are made to the network's RF components based on the validated configurations. Reconfiguration of power components 250A, involves implementing the validated power configuration plans by altering the network's RF power settings and possibly modifying or selecting specific hardware components. For example, the process may include adjusting the transmission power levels of different cell sites to the values recommended by the RF Power Planning Engine, such as reducing power output in urban areas to minimize interference and increasing power in rural sites to enhance coverage. Modifying the mechanical or electrical tilt of antennas is another example, where tilt angles might be changed to improve coverage in suburban regions while minimizing overlap with neighboring cells.

Additionally, the process may involve selecting and installing new hardware components like baseband units, radio units, and antennas as per the specified recommendations. For example, replacing an existing antenna with a higher gain model can improve signal penetration in high-rise buildings. In some embodiments, software configuration changes may also be part of this reconfiguration, where updates or modifications to control software can enhance hardware performance; deploying new software versions may enable advanced features like dynamic beamforming or auto-tilt adjustments. Integrating vendor-specific equipment is another operation, ensuring hardware from different vendors works seamlessly together by following O-RAN standards. For example, configuring a baseband unit from one vendor to operate with a radio unit from another vendor ensures interoperability and optimal performance.

Periodic reconfiguration, such as increasing power levels and adjusting tilt settings in tourist-heavy areas during peak seasons and adjusting them during off-peak times, is also a key aspect, helping conserve energy and reduce interference. These operations collectively ensure that the network remains optimized, regulatory compliant, and capable of delivering reliable service while adapting to dynamic conditions and technological advancements.

Finally, network KPIs monitoring operation 252A involves continuously monitoring key performance indicators (KPIs) of the network to ensure that the reconfigured power settings and hardware modifications meet the desired performance standards and do not negatively impact the network's overall functionality.

In some embodiments, the network KPIs monitoring operation may track various metrics such as signal strength, coverage area, call drop rates, data throughput, latency, and user experience quality. For instance, the system might monitor signal strength across different geographic regions to ensure that the new power settings provide consistent and reliable coverage. Similarly, tracking call drop rates and data throughput can help identify any adverse effects of the reconfiguration on network performance, allowing for prompt corrective actions if necessary.

Further, in some embodiments, this component might include automated alerts and reporting mechanisms to flag any significant deviations from expected performance levels. For example, if the latency increases beyond acceptable thresholds or if there is a sudden spike in call drop rates, the monitoring system can generate alerts for network operators to investigate and address the issue promptly. Additionally, periodic reports summarizing the performance metrics and trends over time can provide valuable insights for ongoing network optimization efforts.

FIG. 2B depicts an illustrative embodiment of a method in accordance with various aspects described herein. [0102] FIG. 2B depicts an illustrative embodiment of a method in accordance with various aspects described herein. Method 200B may be useful for configuring and simulating RF power settings for cell sites using a large language model and a generative AI-driven chatbot. In some embodiments, method 200B may be performed by an electronic system, a server, a processing system, or any other system capable of performing as described herein.

At block 210B, the method 200B involves training an RF Power large language model (RFP-LLM) using historical RF cell power configurations, vendor hardware, and software specifications, FCC requirements, and O-RAN standards. In some embodiments, block 210B includes compiling a comprehensive dataset that encompasses RF power configurations, specifications from various vendors, regulatory constraints, and industry standards. For example, the RFP-LLM may be trained on historical data from cell sites, including power configurations used in different geographical areas and operational conditions. Further, in some embodiments, the RFP-LLM capability comprises training using iterative prompt engineering by network domain experts and feedback from network operators to improve predictive accuracy and resolution recommendations.

At block 220B, the method 200B provides an interactive generative AI-driven chatbot configured to query the RFP-LLM to determine RF power settings for cell sites. In some embodiments, block 220B includes deploying the chatbot on a server or cloud-based platform, enabling network operators to interact with the RFP-LLM through a user-friendly interface. For example, the chatbot may be accessible via a web portal where operators can input specific queries related to power settings for various RF scenarios. The chatbot may also be configured to provide real-time recommendations for network optimization based on the RFP-LLM's predictions.

At block 230B, the method 200B involves generating, by the RFP-LLM, power configuration plans for the cell sites. In some embodiments, block 230B includes analyzing the inputs from the chatbot to produce detailed power configuration plans tailored to the operational requirements of specific cell sites. The plans may take into account various factors, including current network load, geographical conditions, regulatory constraints, and potential call flow failure patterns. The RFP-LLM may prioritize potential call flow failure patterns based on their likelihood of occurrence and potential impact on network performance.

At block 240B, the method 200B involves simulating, by a simulation engine, the RF power configuration plans to evaluate their effectiveness in meeting competing RF use case needs and conforming to FCC requirements. In some embodiments, block 240B includes creating a virtual model of the network environment to test the proposed power configurations. For example, the simulation may consider various parameters such as signal strength, interference, and coverage areas to determine the configuration's impact. The simulation engine may simulate potential call flow failure patterns in a controlled environment during off-business hours to minimize impact on live network operations.

At block 250B, the method 200B involves configuring or reconfiguring at least one RF cell power component based on the RF power configuration plans. In some embodiments, block 250B includes applying the validated power configuration plans to the actual cell sites. This may involve adjusting the power output of various radio transmitters, updating software configurations, or making hardware adjustments to optimize performance and ensure compliance with regulatory standards.

Additional aspects of method 200B may include continuously monitoring network performance Key Performance Indicators (KPIs) to detect and mitigate any adverse impact resulting from the implemented configurations. The insights gained from monitoring KPIs such as latency, packet loss, throughput, jitter, and call drop rates help operators make further adjustments to maintain the desired network performance.

Method 200B may also involve generating reports summarizing multiple potential call flow failure patterns, associated resolution hints, and simulation results. These reports provide a comprehensive overview of network performance and suggested optimizations. The method further includes using feedback from network operators to train the RFP-LLM, improving its predictive accuracy and resolution recommendations over time.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

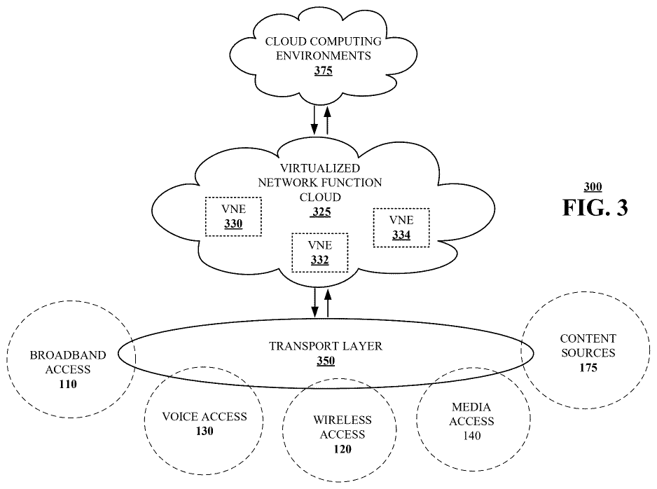

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part Generative AI-driven RF power system design and configuration for communications networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

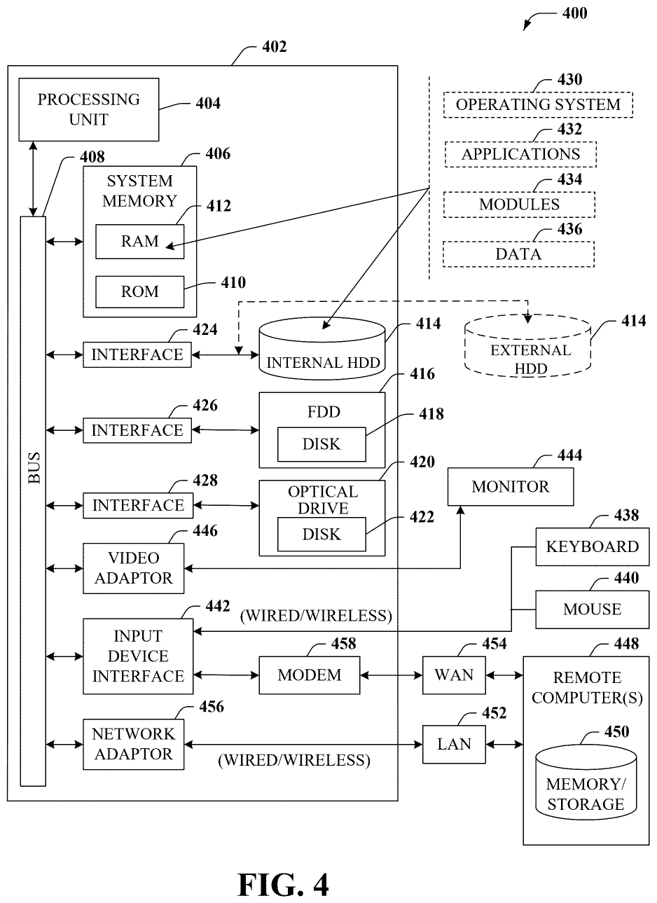

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part Generative AI-driven RF power system design and configuration for communications networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

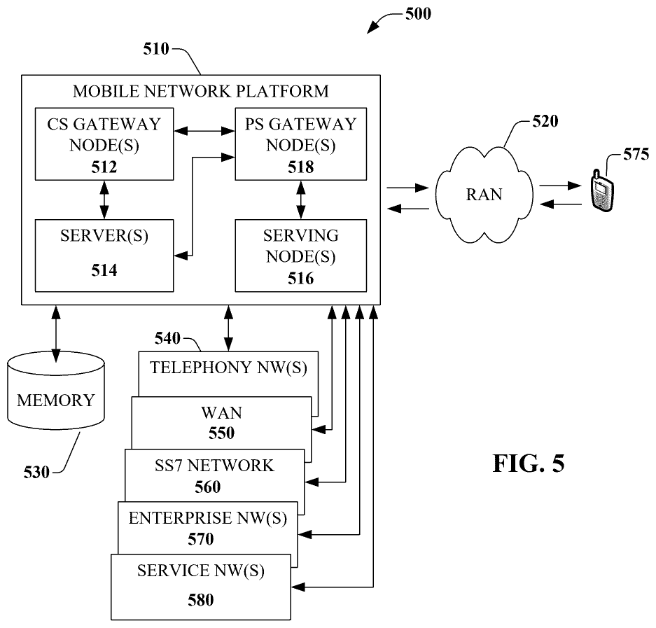

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part Generative AI-driven RF power system design and configuration for communications networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

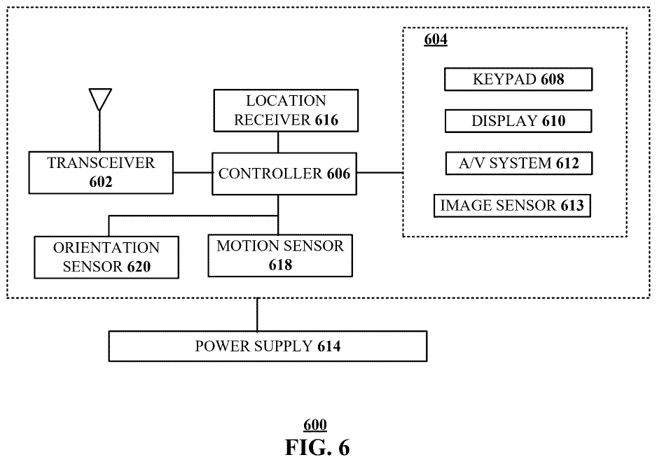

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part Generative AI-driven RF power system design and configuration for communications networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
training an RF Power Large Language Model (RFP-LLM) using historical RF cell power configurations, vendor hardware and software specifications, FCC requirements, and O-RAN standards;
providing an interactive Generative AI-driven chatbot configured to query the RFP-LLM to determine RF power settings for cell sites;
generating, by the RFP-LLM, RF power configuration plans for the cell sites;
simulating, by a simulation engine, the RF power configuration plans to evaluate an effectiveness in meeting competing RF use case needs and conforming to Federal Communications Commission (FCC) requirements; and
reconfiguring at least one RF cell power component based on the RF power configuration plans.

2. The device of claim 1, wherein the operations further comprise training the RFP-LLM using simulation results.

3. The device of claim 2, wherein the reconfiguring the at least one power component comprises modifying a network configuration based on the simulation results.

4. The device of claim 1, wherein the training the RFP-LLM comprises training using iterative prompt engineering by network domain experts.

5. The device of claim 1, wherein the wherein the reconfiguring the at least one RF cell power component comprises setting an output power of an amplifier.

6. The device of claim 1, wherein the simulation engine is configured to simulate the RF power configuration plans in a controlled environment during off-business hours to minimize impact on live network operations.

7. The device of claim 1, wherein the operations further comprise continuously monitoring network performance Key Performance Indicators (KPIs) to detect and mitigate any adverse impact.

8. The device of claim 1, wherein the operations further comprise training the RFP-LLM using feedback from network operators to improve a predictive accuracy of the RFP-LLM's.

9. The device of claim 1, wherein the reconfiguring the at least one RF power component comprises changing an antenna tilt.

10. The device of claim 1, wherein the reconfiguring the at least one RF power component comprises selecting a baseband unit, an amplifier, an antenna, or any combination thereof.

11. A non-transitory machine-readable medium, comprising executable instructions that, when executed by a processing system including a processor, facilitate performance of operations, the operations comprising:
training an RF Power Large Language Model (RFP-LLM) using vendor hardware and software specifications, FCC requirements, and O-RAN standards;
providing an interactive Generative AI-driven chatbot configured to query the RFP-LLM to determine RF component selections for cell sites;
generating, by the RFP-LLM, RF power configuration plans for the cell sites;
simulating, by a simulation engine, the RF power configuration plans to evaluate an effectiveness in meeting competing RF use case needs and conforming to Federal Communications Commission (FCC) requirements; and
modifying at least one RF cell power component based on the RF power configuration plans.

12. The non-transitory machine-readable medium of claim 11, wherein the modifying the at least one RF cell power component comprises selecting a baseband unit to be used in the RF cell.

13. The non-transitory machine-readable medium of claim 11, wherein the modifying the at least one RF cell power component comprises selecting a power amplifier unit to be used in the RF cell.

14. The non-transitory machine-readable medium of claim 11, wherein the modifying the at least one RF cell power component comprises selecting an antenna to be used in the RF cell.

15. The non-transitory machine-readable medium of claim 11, wherein the modifying the at least one RF cell power component comprises selecting a plurality of amplifiers to be used in a plurality of RF cells.

16. A method, comprising:
training, by a processing system including a processor, an RF Power Large Language Model (RFP-LLM) using historical RF cell power configurations, vendor hardware and software specifications, FCC requirements, and O-RAN standards;
providing, by the processing system, an interactive Generative AI-driven chatbot configured to query the RFP-LLM to determine RF power settings for cell sites;
generating, by the processing system using the RFP-LLM, RF power configuration plans for the cell sites;
training the RFP-LLM, by the processing system, using simulation results from a simulation of the RF power configuration plans; and
reconfiguring at least one RF cell power component based on the RF power configuration plans.

17. The method of claim 16, wherein the generating the RF power configuration plans include comprises determining an amplifier model to be used in a plurality of cell sites.

18. The method of claim 16, wherein the generating the RF power configuration plans include comprises determining an amplifier transmit power level.

19. The method of claim 16, wherein the generating the RF power configuration plans include comprises determining a baseband unit model to be used in a plurality of cell sites.

20. The method of claim 16, wherein the generating the RF power configuration plans include comprises determining an antenna model to be used in a plurality of cell sites.
